(19) United States
(12) Patent Application Publication
(10) Pub. No.: US 2025/0116874 A1
(43) Pub. Date: Apr. 10, 2025

(54) BEAM SPLITTER SYSTEM FOR THE FILM INDUSTRY

(71) Applicant: Screen Plane GmbH, Muenchen (DE)

(72) Inventor: Sebastian CRAMER, Muenchen (DE)

(21) Appl. No.: 18/908,193

(22) Filed: Oct. 7, 2024

(30) Foreign Application Priority Data
Oct. 10, 2023 (DE) 102023127582.8

(51) Int. Cl. G02B 27/10; G02B 27/12

(52) U.S. Cl. CPC G02B 27/106; G02B 27/123

(57) ABSTRACT

A beam splitter system includes a recording lens, at least two cameras and a relay unit with at least one beam splitter element, a first relay lens and at least two second relay lenses. The recording lens provides a real intermediate image which is imaged by the first relay lens. The at least one beam splitter element divides the imaging beam path of the first relay lens into at least two imaging paths, and the at least two second relay lenses in the at least two second imaging paths each image the intermediate image onto a sensor of the at least two cameras. The focal length of the first relay lens does not differ from the focal lengths of the at least two second relay lenses by more than 10% and the beam splitter system further comprises a device which is designed to optionally modify the image to be imaged in at least one of the at least two imaging paths.

### TECHNICAL FIELD

The invention relates to a beam splitter system for the film industry. In particular, the invention relates to a beam splitter system with the features of claim 1.

### BACKGROUND

In the media industry, it is becoming increasingly important to create variations of one and the same film project using different parameters. This can affect the frame rate, i.e., the number of images recorded per second, but also the aspect ratio of a film, to name just two examples.

For example, cinema films have a frame rate of 24 frames per second, while television pro-ductions in Europe run at 25 frames/s and in the USA 30 frames/s is common. Frame rates of 60 frames/s are usually used for the Internet. These different frame rates are usually adjusted by periodically repeating images from a picture sequence, by digital interpolation or by changing the playback speed. However, such conversions are often associated with dis-turbing losses in quality or can be very complex, as is the case with interpolation.

Conventional films also usually have a horizontal orientation, which means the horizontal edge of the image window is longer than the vertical one. Common aspect ratios are often 16:9, 4:3 or 2.4:1. For social media vertical aspect ratios are primarily required, often in an aspect ratio of 9:16.

In order to implement this required aspect ratio, a vertical image section is usually determined from the horizontal oriented image and cropped laterally accordingly. The disadvantage of this is that a significant amount of cropping is necessary for a vertical orientation. In addition, simply cropping the image to 9:16 often results in a section that is too narrow to reproduce a scene intelligibly. It is therefore advantageous if the vertical aspect ratio is not only formed from a portion of the original image with a horizontal orientation, but can itself have an image height that is greater than the image height of the horizontally oriented original image.

An obvious solution would be to place two cameras with identical lenses next to each other, with one rotated by 90° around the optical axis, thus creating two images with the required parameters or placing them next to each other to run the positioned cameras at different frame rates if a variation with different frame rates is required. A disadvantage of this, however, is that professional film cameras are usually 15 cm wide or more and the lateral offset caused by this is too large. This would mean, for example, that an actor would look into the lens of one camera during a close-up, while looking sideways past the other camera.

Currently, such requirements, especially when different frame rates or different exposure times are required, are often implemented with stereoscopic mirror rigs, in which two cameras with identical lenses are used, with one camera filming into a semi-transparent beam splitter mirror and the other through it. By using a beam splitter mirror and the setting options of such a rig, in particular the ability to determine the lateral offset of the two cameras, it is possible to reduce this offset to zero and to record two completely identical images with both cameras. If the frame rate, exposure time, aspect ratio or other parameters are now changed on one of the two cameras, recordings can be made with the requirements listed above. However, stereoscopic mirror rigs are complex to operate, require specialist person-nel, are expensive to purchase and contain a multitude of possible sources of error.

For a cameraman, the choice of the recording lenses used with their respective characteristics is an important decision, as is the choice of a recording camera. Both components determine the “look” of a film project. There is also an idea of which focal length can be used to achieve certain angles of view and compositions. It is therefore very important for the cameraman to be able to work with known and familiar equipment when creating different image variants. This includes the recording lens, the recording camera, but also the angles of view that result for a certain focal length with a given sensor size.

A multiplex camera is known from WO 01/86348 A1, which uses relay lenses and beam splitters to split an image beam and direct it to up to four cameras. The cameras run in synchronization with each other in order to then create new image sequences from the individual images, which are mainly generated by interweaving the individual images from the respective cameras. In practice, however, it is often necessary to set significantly more parameters in a very differentiated manner in addition to the frame rate, exposure time and focus presented here in order to obtain the recording variants desired today.

U.S. Pat. No. 5,900,942 A presents a multispectral imaging system that can be used to create multispectral image variants of a scene. An intermediate image is divided using relay lenses, beam splitters and filters so that different spectral ranges of the same original image are made available to the sensors of different cameras.

DE 10 2012 005 939 A1 achieves different imaging variants using a beam splitter element that is inserted into the beam path of a zoom lens and transmits the light to two sensors, in particular to achieve different polarization variants of the two images. Such a design works without an intermediate image and does not allow the use of interchangeable lenses.

U.S. Pat. No. 8,320,047 B2 presents a system that splits the beam of a lens to several image sensors with different light intensities.

The invention is therefore based on the object of creating an easy-to-use system which provides at least two independent cameras or camera sensors with the image circle of a scene from an identical point of view, wherein at least one of the images to be imaged on the at least two sensors is modified, but remains the general characteristics of a recording lens in terms of the focal length and the “look”.

This object is achieved by the beam splitter system according to claim 1, which is designed to image an image or an image sequence (film sequence) of a scene with an identical point of view on the sensors of at least two cameras and to optionally modify the images to be imaged on the sensors of the at least two cameras relative to one another. The image modification can take place directly in the imaging paths of the beam splitter system or can be achieved by adjusting or positioning the at least two cameras relative to one another.

Advantageous further developments of the invention are the subject matter of claims 2 to 20. In particular, the beam splitter system according to the invention is characterized by a simpler construction and operation compared to other systems, in particular the stereoscopic mirror rigs discussed above.

### SUMMARY OF INVENTION

### General Structure

Common recording lenses can not only produce a direct image on an imaging sensor from the emitted or reflected light of a scene, but also a real intermediate image. If such a recording lens is separated from the camera at the lens mount, a relay unit can be inserted between the recording lens and the camera in the imaging beam path, which images the intermediate image on the sensor of a camera. The recording lens that produces the intermediate image can be either a fixed focal length lens or a zoom lens. A relay unit is often designed in two parts, consisting of a first relay lens and a second relay lens. Such a two-part design is often designed so that the first relay lens essentially images the intermediate image to infinity.

The beam splitter system according to the invention comprises a relay unit with a first relay lens and at least two second relay lenses. The beam splitter system also has a recording lens on the light entry side, which is mounted on the relay unit by means of its lens mount. It provides a real intermediate image in the imaging beam path, which is positively refracted by the first relay lens or is imaged to infinity and is divided by a beam splitter element into two imaging paths, formed from the transmission and the reflection of the imaging beam path. Such a beam splitter element can be used as a splitter plate, splitter prism or splitter cube. The splitter ratio and splitter behavior of the beam splitter element between transmission and reflection are described in more detail below.

The intermediate image is projected onto the sensor of the first camera by a second relay lens, which is positioned in the first imaging path of the transmitted radiation. The intermediate image is projected onto the sensor of the second camera by a further second relay lens, which is positioned in the reflected, second imaging path. The cameras are also mounted separably (detachably) to the relay unit via their camera mount.

The relay unit can advantageously be designed as a separate assembly in its own housing, to which the recording lens and the two cameras can be detachably mounted (flanged). In this case, the relay unit comprises a camera-sided mount for attaching the recording lens, the first relay lens, the beam splitter element, a second relay lens for each imaging path and a lens-sided mount for mounting a camera. A camera is defined as a unit that has its own sensor and generates images by converting light radiation into electrical signals, which are pro-cessed in the unit and recorded internally or externally. Such a camera has a camera-sided mount for attaching recording lenses, although the recording lenses are not part of the camera.

Using the relay unit according to the invention, two identical image circles of an intermediate image can be projected onto the respective sensors of the two cameras. If a modification is made to at least one of the images to be projected onto the sensors of the two cameras by means of a further device in the relay unit or by means of further settings in the relay unit or one of the two cameras, two variants of a picture sequence can be generated. These possible modifications are explained in more detail below.

The relay unit forms a complete beam splitter system with the detachably fixed (flange-mounted) recording lens and the detachably fixed (flange-mounted) cameras. The relay unit is the central unit, which is also the center of gravity of the entire beam splitter system. It is therefore useful for the relay unit to have connecting devices for a camera tripod or other camera support devices on its underside or the outer surfaces. These can be screw threads in particular. Sliding plates can be mounted to these to balance a complete beam splitter system.

In addition to the described light entrance and light exit, the relay unit advantageously has an opaque, completely closed housing to prevent the entry of stray light.

It is also possible to place additional beam splitter elements in the parallel beam path, which split the light into additional imaging paths, which are then imaged onto the sensors of additional cameras using additional relay lenses. This is useful if more than two recordings with different settings or modifications are required.

The possibility of such further developments with more than one beam splitter element and more than two imaging paths is expressly pointed out. However, for the sake of simplicity, the possible designs and further developments are explained below using beam splitter systems with only two imaging paths and two cameras.

### Relay Lens

The first relay lens and the at least two second relay lenses of the beam splitter system according to the invention advantageously have an identical or almost identical focal length, provided that the beam path between the two lenses is essentially collimated. This ensures that the image size displayed on the respective sensors of the two cameras corresponds to the size of the intermediate image.

It can also be useful to determine the focal length of the at least two second relay lenses slightly larger than on the first relay lens, for example to avoid or reduce vignetting or edge blurring caused by the relay transmission. The image displayed on the respective sensors is therefore slightly larger than the intermediate image. For this purpose, the focal length of the second relay lenses should be selected to be in a range of 0 to 10% larger than the focal length of the first relay lens in order to maintain the basic character of the focal length of the recording lens.

However, it is also possible for the focal lengths of the first relay lens and the second relay lenses to be significantly different, for example to adapt the image circle of the recording lens to the sensor size of the cameras. The focal lengths of the two second relay lenses of both imaging paths can also be designed differently, for example if the sensor sizes of the two cameras are different and need to be adapted, or if a larger image section is required on one camera.

In the film industry, a recording lens is often designed in such a way that it can fill the image window of a film camera or a sensor of a camera with the size of Super 35 mm in the image. This recording format has a defined size of 24.89×18.66 mm and results from the maximum usable area of the individual image fields in film cameras, which are arranged at a distance of four perforation holes in vertical image orientation. A recording lens that can fully image the Super 35 format therefore has an image circle of at least 31.1 mm or 32 mm. Since Super 35 recording lenses are a widespread standard, it is advantageous if the relay unit with the first relay lens and the two second relay lenses can also image an image circle of at least 31.1 mm or 32 mm on the respective sensors. It would be advantageous if the transmission would even be a little larger, for example with an image circle diameter of 34-35 mm, to create space to slightly shift a sensor section with a size of Super 35 in the horizontal and/or vertical direction, for example to align the two images so that they are congruent with each other.

In an advantageous embodiment, at least one of the second relay lenses can be interchangeably mounted in one of the imaging paths in order to enable the use of a longer focal length for this second relay lens and to enlarge the image of this imaging path. It is also conceivable to use a zoom lens as the second relay lens in at least one of the two imaging paths.

The first relay lens is focused on the focal plane of the intermediate image. This focus setting can be rigid or adjustable. A rigid setting can be achieved, for example, by tight manufacturing tolerances or by using shims. A variable setting can be implemented using a worm, a fine thread, an internal focus or a floating element. Since the flange focal distance of the first relay lens is primarily adjusted here, a focusing device with a small adjustment range of a few tenths of a mm is usually sufficient.

The focusing of the at least two second relay lenses onto the sensor plane of the respective cameras can be rigid or adjustable. A rigid adjustment can be achieved, for example, through tight manufacturing tolerances or through shims. A variable adjustment option using a focusing device is advantageous here. This can be done using a worm, an internal focus or a floating element. Since the flange focal distance of the second relay lens is primarily adjusted here, a focusing device with a very small adjustment range of a few tenths of a mm is usually sufficient. This can be achieved, for example, using a fine thread on the lens assembly of the respective second relay lenses, which determines the axial displacement of the lens assembly using an axially guided adjustment ring. Such an adjustment is advantageously self-locking or fixable so that the flange focal distance of the second relay lens does not change during recording or the transport of the system.

The focusing options described here primarily serve to align the first relay lens and the second relay lenses to each other in their imaging paths and to the sensor planes of the cameras and to the recording lens.

By means of an adjustable focusing device of at least one of the two second relay lenses, for example, manufacturing tolerances with regard to the flange focal distance of the cameras can be adjusted and compensated for. A further advantage of adjustable focusing of the second relay lenses arises when the cameras record the light in different spectral ranges, in particular when one of the cameras records the visible light while the other records the infrared or near-infrared spectral range. Due to the different refraction behavior of different spectral ranges, it is advantageous if the focusing of at least one of the two second relay lenses can be individually adjusted to the focusing of the other imaging path. Ideally, both second relay lenses have such a focusing device, since this allows both cameras to be fully and inde-pendently adjusted from one another. Another application is the targeted setting of a slightly different plane of focus of the image on the sensor plane on one of the second relay lenses, for example to increase the depth of field. If the focus on one of the second relay lenses is slightly shifted, this camera will record a slightly different plane of focus than the other camera. The distance between these two planes of focus can be determined so that the depth of field of both images overlap slightly. There are therefore image areas that are recorded by one camera with the highest possible sharpness, which border to image areas that are recorded by the other camera with the highest possible sharpness.

In photography, a so-called focus stacking method is well known for increasing the depth of field. This involves combining the sharpest parts of several images taken one after the other with a slightly shifted plane of focus to create a new image with an increased depth of field.

Such a method can also be used for picture sequences using the beam splitter system according to the invention. By electronically selecting and combining the sharpest image areas of each individual image of the two imaging variants, a new image sequence with an increased depth of field can be created.

With regard to the speed of the relay unit, it should be noted that the maximum transmitta-ble luminous flux is determined by both the speed of the recording lens and the speed of the first relay lens and the speed of the second relay lenses. The maximum aperture of the entire system can only be as large as the aperture of the slowest component. For example, if the relay unit, consisting of a first relay lens and at least two second relay lenses, has an aperture of 4 as its widest opening and the recording lens has an aperture of 1.4, the maximum aperture is a 4, even if the recording lens is set to an aperture with a larger opening than 4. If the aperture of the recording lens is changed in the range of 1.4 and 4, no change in the image can be seen, in particular the depth of field and the bokeh do not change. In this case, the depth of field that corresponds to an aperture of 4 is always transmitted. Changes in the depth of field only become visible when an aperture value higher than 4 is set on the recording lens.

It is therefore advantageous if the relay unit itself has as high maximum lumious flux, for example an aperture of 2, since otherwise the recording lenses mounted on the beam splitter system are severely limited in their speed and recordings with a shallow depth of field are no longer possible since they are not transmitted by the beam splitter system.

The desired aperture for a shot is preferably set on the recording lens. This is advantageous because both image paths share the same aperture setting and therefore the same depth of field. Since the recording lens is familiar to a cameraman, he can set the aperture as he is used to.

However, it is also conceivable that the aperture setting is made on the first relay lens. Here, too, the selected aperture would be the same for both imaging paths. Changing the aperture setting on one of second relay lenses is also possible, but this means that the depth of field is no longer the same in the image from both cameras if the apertures are set differently.

It can therefore be stated that the aperture can be determined on one or more of the fol-lowing lens components: on the recording lens, on the first relay lens and/or on the at least two second relay lenses, even if in most cases it is advantageous to set the aperture on the recording lens.

### Filters to Adjust Exposure

The actual exposure time of cameras can be determined as an absolute value or as a relative value in regards to the frame rate. The maximum possible exposure time is second/frame rate. In classic film cameras, the exposure time is determined by a rotating shutter, which usually has a sector angle of 180°. Therefore, the exposure time of a digital motion picture camera is often as well half the maximum exposure time, which corresponds for example to a time of 1/48 s at 24 frames per second. If both cameras are set to a relative exposure time, their respective exposure time depends on the frame rate.

For example, the exposure time for a 180° shutter at 24 fps (frames per second) is 1/48 s and at 60 fps 1/120 s. This means that the sensor of the camera running at 24 fps receives significantly more light during a single exposure, namely by a factor of 2.5, which equals to 1.3 stops. If the sensors have the same sensitivity and the beam splitter has a 50:50 ratio between transmission and reflection, the light intensity of the two imaging paths must be adjusted to each other.

In order to compensate for this difference in exposure time, it is advantageous to adjust the light intensity using a gray filter, which is inserted into the imaging path of the camera running at 24 fps after beam splitting. Gray filters only change the light intensity, but not the character of a light beam, and are often available in thirds of an stop, but sometimes only in full stop steps. In both cases, the gray filter that is closest to the calculated value of the required light reduction is used to adjust the light intensity. In the example above, if only full stops are available, this is a gray filter with a reduction of one stop.

Small differences of less than one stop can be completely corrected in post-production during what is known as color grading. This means that both cameras now have a correct and closely adjusted exposure and deliver two otherwise identical images, one with a frame rate of 24 fps and the other at 60 fps.

Instead of using a gray filter, it is also possible to use a beam splitter element to modify the light intensity of the imaging paths, which, for example, has a splitting ratio of 66.6:33.3 and assigns twice the light intensity to the path of the camera running at 60 fps. In this case too, the exposure would be adjusted by a full stop to that of the other path, which can be fully compensated in the color grading of the recording.

It is also possible to adjust the exposure time of the camera running at 24 fps to the exposure time of the camera running at 60 fps, so that both sensors expose each individual image for the same length of time. However, the relative motion blur of the two images is no longer the same. This would mean that the camera running at 24 fps would have a less smooth appearence, which could look more “strobe-like”. This may be creatively desired, otherwise it is recommended to adjust the exposure using gray filters and/or the splitting ratio of the beam splitter element.

Compensating the exposure by stopping down the second relay lens of the camera running at 24 fps by a full stop, or more precisely by 1.2 stops, is therefore not advisable, as this changes the depth of field of this imaging path and is therefore no longer identical to the second imaging path. This may be creatively desired, but should otherwise be avoided.

### Using Other Filters

In addition to gray filters, a variety of different filters can be used to modify one or both imaging paths to achieve different imaging variants of a scene. These can, for example, be filters that block certain areas of the visible or non-visible light spectrum, in particular those that only block the infrared or near-infrared range or only allow this spectral range to pass through, which is explained in more detail below.

It is also conceivable to use effect filters, such as star filters or streak filters, which create a star image or a stripes in bright, point-shaped areas of the image. Likewise, at least one of the image paths can be modified using soft-focus filters, low-contrast filters, color effect filters or gradient filters. Another area of application for filtering can be achieved by using polarization filters, in particular for creating cross-polarized images, which is explained in more detail below.

It is advantageous to place filters for each imaging path between the beam splitter element and the second relay lens. If the first relay lens is designed in such a way that it essentially images the intermediate image to infinity, the thickness of the filter glass has no influence on the image. It is also possible to position a filter in the imaging path between the respective second relay lenses and the sensor or to integrate it into the second relay lenses.

The filters can be, for example, screw filters, foil filters, round or square filter disks or have other designs. At least one imaging path should have such a filter option in order to enable adjustments of the exposure and/or further modifications to the imaging path. Ideally, each imaging path has its own, independent filter option.

The filters can be inserted into a filter holder and fixed in place, for example by means of a clamp or a screw ring. Such a filter holder can be designed as a filter insert, for example, which is mounted in a guide that is aligned perpendicular to the optical axis of the imaging path. The positioning of a filter can be fixed using the filter holder by means of a screw connection, a catch or a clamp in the relay unit so that the filter is held securely in position during recording or transport. The filter holder is advantageously connected to the relay unit in a light-tight manner to prevent unwanted light from entering.

When using polarizing filters, streak filters, star filters or graduated filters, the angle of rotation of the filter should be able to be determined centrally around the optical axis, as the filter produces different results depending on the set angle of rotation. It is therefore advantageous if a cameraman can determine and set the angle of rotation of filters himself when filming.

This is achieved by mounting the filter holder with a pivot bearing, preferably with a rotating bearing ring, which enables to set and fix angle of rotation of the filter around the optical axis. It is case it is advantageous to be able to set the angle of rotation even when the filter holder is already in place. This can be achieved, for example, by transmitting the filter rotation position using a gear, a toothed belt or a friction wheel. The desired rotation can be fixed in a self-locking manner, by clamping or locking.

If a specific filter is introduced into only one of the two imaging paths, recording variants can be realized with otherwise identical recording settings, while the filtered path shows the filter characteristics and filterless variant, does not have them. In post-production, any intermediate value of the filtered and unfiltered version can be determined by mixing the two recordings and rendering them accordingly. It is also possible to create a dynamic transition from the filtered version to the unfiltered version or vice versa using a crossfade. This gives the cameraman or director the opportunity to determine the intensity of a filter or the time and duration of a dynamic change to or from such a filtered version after the actual recording completely freely, in accordance with creative requirements.

### Use of Different Beam Splitters

The determination of the light intensity of the at least two imaging paths can be determined and modified not only by using gray filters but also by means of the splitting ratio of the beam splitter element.

One obvious possibility is to use a beam splitter element at a 50:50 ratio, which creates two imaging paths with equal light intensity. If a different light intensity is required for the respective imaging paths, for example because the exposure times are different, the allocation of the amount of light per imaging path can be modified and determined using the splitting ratio of the beam splitter element.

With a beam splitter element at a 50:50 ratio, the light loss for each imaging path is one stop, while with a 75:25 ratio it is approximately 0.4 stops for one imaging path and two stops for the other imaging path. If a beam splitter ratio is selected that reflects the differences in the exposure settings of the two cameras as accurately as possible, this ensures the greatest possible use of the available light, because different exposures do not have to be compensated for by gray filters.

Since the beam splitter element plays an important role in compensating for differences in exposure, the beam splitter element is advantageously designed in such a way that it is separably (detachably) connected to the relay unit and variants with different splitting ratios or splitting properties can be used and fixed in position with precise accuracy. This is advantageously achieved by means of a registration which engages in a holder of the relay unit. Such a holder should be able to be fixed in the relay unit, for example by means of a clamp, a screw connection or a lock. The beam splitter holder is advantageously designed in such a way that it can be connected to the relay unit in a light-tight manner in order to prevent unwanted light from entering.

By using beam splitter elements with adapted splitting ratios, differences in exposure time, sensor sensitivity, aperture setting, different filtering or in the imaging of different spectral ranges can be fully or partially compensated.

The two imaging paths can also be modified using polarizing beam splitters, where the splitting ratio is determined by the polarization angle of the incoming light.

Another way of modifying the imaging paths is to use a beam splitter element, where the splitting ratios are determined by the wavelength of the incoming light, in particular with a cutoff wavelength between 700 and 780 nm. The incoming light is split by such a beam splitter into visible light and infrared or near-infrared light. The prerequisite for the recording of infrared light by the sensor of the corresponding camera is that it does not have its own IR blocking filter.

Independent of the light loss caused by the splitting ratio between transmission and reflection at the beam splitter element, the system also has an additional small light loss caused by residual reflections when the light beam passes through surfaces with different refractive indices and in the glass itself. Since this is very small, it will not be explained in more detail here.

Any combination of the modification options explained above may be used to adjust the exposure. For example, if significant differences between the two exposure times are desired, it can be useful to initially achieve a rough adjustment of the exposure using a suitable splitting ratio of the beam splitter element, as this directs the maximum light intensity to the camera sensors. Fine tuning can then be achieved by additionally using gray filters. An initial predetermination of the splitting ratio on the beam splitter element is also helpful as beam splitting plates, beam splitting prisms or beam splitting cubes are often only available with a few splitting ratios and can therefore be adjusted less precise than gray filters can.

In most cases, adjusting the exposure using the sensor's exposure time does not make sense, as this changes the characteristics of the representation of moving objects in such a way that the motion blur is no longer represented in the same way.

### Recordings of Image Sequences in Different Spectral Ranges

Sensors in digital film cameras are usually designed to be sensitive to light in the visible spectrum, but insensitive to other spectral ranges, particularly infrared and near-infrared light. This is usually achieved by a short-pass filter that is mounted in front of or on the sensor and blocks the light above a cutoff wavelength of around 780 nm. This is also known as an IR blocking filter, which most sensors in digital cameras have.

Some of these filters are firmly cemented to the sensor, but some are removable. If such a short-pass filter is removed and replaced by a complementary long-pass filter that only lets light through at a cutoff wavelength of around 780 nm, then such a camera only records infrared light, particularly near-infrared light, while visible light is no longer recorded. A certain degree of selectivity is given in the cutoff range due to the filter. The cutoff wavelengths in photography and film are sometimes in a range up to 700 nm. The application areas presented therefore also apply to spectral ranges that are not separated exactly at 780 nm and are in the range from 700 nm to 780 nm.

If the imaging paths of both cameras are now equipped with complementary long- and short-pass filters with a cutoff wavelength of 700 nm to 780 nm, identical, congruent images of a scene can be recorded, which differ in that one camera records only visible light and the other only IR light.

If the IR short-pass filter, which is usually mounted in front of or on the sensor, is removed from a camera or if the sensor does not have such a filter, a long-pass filter that is then required, blocking the visible light range, can be placed at various points in the imaging path of the infrared path. On the one hand, this can be positioned directly in front of the sensor, but it can also be arranged in the imaging path between the beam splitter element and the second relay lenses, in particular in the filter holder provided for this purpose.

In addition to the red, green and blue color channels of visible light, an additional infrared channel is created and assigned to the picture sequence. This can contain additional image information or, as an additional auxiliary channel, can contain masks for separating image elements, markings or information about the depth of a scene.

One example of how additional image information can be obtained is that in an infrared photo, plant leaves are shown almost white, while a blue sky is usually shown black. This type of effect makes it possible, for example, to shoot so-called “day for night” scenes. A scene is shot in daylight and appears in the finished film as a night scene. This type of image effect can be achieved by depicting a black or almost black sky in an infrared photo. To do this, the red, green and blue color channels of one camera are digitally merged with the infrared channel of the other camera after the shot has been taken until the desired image effect is achieved, particularly in order to add colored image elements to a darkened infrared channel.

In a further development, one or more light sources are assigned to the beam splitter system, which are adapted so that they emit either only visible light or only infrared, in particular near-infrared light.

Light sources that emit only near-infrared light are commonly known, particularly in the case of LEDs. If a background of a scene is illuminated exclusively with such a light source, while a foreground is illuminated exclusively with visible light, and if the spatial distance between the foreground and background ensures sufficient separation, masks can be created using the infrared channel that can be used to isolate a foreground element recorded with visible light. This can then later be combined with another background image, for example, using the image from the infrared channel as a mask.

If a light source emits both visible light and infrared light, it can be filtered by an appropriate short-pass filter or long-pass filter which is positioned in the light exit so that it emits only visible light or infrared light.

Another application can be achieved, for example, by illuminating an actor with a soft, diffuse light source that only emits light from the visible spectrum. With another, but point-shaped and hard light source that only illuminates the actor in the near-infrared spectrum, a mask can be created in the infrared channel that corresponds to the light distribution of strong sunlight. If the image of the soft representation of the visible light is now split into two different color gradings, one of which corresponds to a darker shadow representation and the other to bright, direct sunlight, a mixed image can be created with the help of the mask of the infrared channel that shows the actor in bright sunlight with corresponding shadow effects. Both the intensity and the time and duration of a transition of such a light effect can be precisely determined later in post-production and offers the cameraman or director a great deal of creative freedom at a later point in time than the actual recording.

In a further development of the invention, the associated light source is a projector which projects patterns onto an actor or a scene exclusively in infrared light. These patterns can be, for example, checkerboard patterns, lines or irregular structures which are only displayed on the sensor of the camera sensitive to infrared light and have no influence on the recording of the visible light of the other camera. These patterns can be used via digital anal-ysis methods to generate depth information of a scene from the image signals. It is therefore possible to use such a method to generate a completely independent depth channel in addition to the color representation of a scene.

### Cross-Polarized Photography

A further development of the beam splitter system is created by the assignment of one or more light sources which emit polarized light and are combined with additional polarized filtering within the beam splitter system.

In cross-polarized photography, an object or actor is illuminated by one or more light sources whose rays are polarized in a defined direction using a polarization filter. If several light sources are used, they advantageously have an identical polarization orientation. A second polarization filter is arranged in front of the camera lens, with an orientation rotated by 90° to the polarization direction of the light source. This completely suppresses reflections from highlights and only the diffuse part of the light is displayed. The impression is of a completely matte image effect that no longer shows any reflections from a light source and appears completely softly lit.

Using the beam splitter system according to the invention and associated polarized light sources, two otherwise identical recordings of a scene can be realized, with a cross-polarized image being recorded in one imaging path and an image with highlights in the other imaging path. This is achieved, for example, by arranging a polarization filter in the first imaging path between the beam splitter element and the second relay lens, which is rotated by 90° to the polarization of the light source. No polarization filter is placed in the second imaging path or this polarization filter has the same orientation as the polarization of the light source. Accordingly, the highlights in this imaging path are not eliminated, but are also imaged. One camera thus records a matte, cross-polarized image free of highlights, while the other camera records a “normal” image effect with highlights.

In computer animation, cross-polarized images of actors are required as textures that are projected or “mapped” onto digital bodies or objects. Since the two images, with otherwise identical camera settings, only differ in that one variant has highlights while the other does not, the highlights can be isolated by subtracting the two images and are thus also available as an additional image channel for the computer animation. This provides a cross-polarized texture and a channel with reflections and highlights for further processing. In addition to being used as textures in computer animation, such cross-polarized images can also be used as visual effects, since the lack of highlights gives the image an unreal and “eerie” character and faces in particular often appear “alien-like”.

Instead of using one or more polarization filters, the imaging paths can also be modified using a polarizing beam splitter element, where the splitting ratio is determined by the polarization angle of the incoming light. As already mentioned, the beam splitter elements can be advantageously exchanged and positioned and fixed depending on the application.

### Registration and Adjustment of the Sensor Section

It is advantageous if both the recording lens and the cameras are mounted separably (detachably) to the relay unit. This enables a cameraman to select a specific recording lens that he prefers from a variety of fixed focal lengths or zoom lenses and to also freely determine the focal length of this recording lens.

He can also choose from different camera types depending on his preference or the requirements of the project. Different camera types may also be used for the two imaging paths. For example, a special slow motion camera can be selected for one imaging path and another camera with a normal frame rate for the second imaging path.

If the recording lens is detachably connected to the relay unit, the relay unit advantageously has a camera-sided mount on the light entry side, which can be a PL or LPL mount in particular, but also another well-known and established mount which is common for professional lenses. This can also be a Canon EF, Canon RF, Nikon F, Nikon Z, Fuji or Sony E mount, for example. By using adapters, a large number of lenses with a specific mount standard can also be adapted to different camera-sided mounts.

If one or both cameras are detachably connected to the relay unit, it is advantageous if they each have a lens-sided mount on the imaging paths of the light exit, which can engage to the mounts of the cameras and be locked there. Such a mount can in particular be a PL mount, an LPL mount or another common mount, such as Canon EF, Canon RF, Nikon F, Nikon Z or Sony E mount.

Current digital film cameras are often very compact and lightweight. It is therefore possible to support the weight of the cameras fully by their camera-sided mount, for example a PL or LPL mount. For additional fixation, the cameras can be fixed to the relay unit using additional support or stabilization elements. This is helpful, for example, if the lock on the camera mount cannot completely prevent a small rotation around the optical axis. Even a small lateral displacement perpendicular to the optical axis cannot be completely prevented due to the tolerances of such mounts. This can also be completely fixed in position using such additional support elements.

If the same sensor section is set on the cameras, the images recorded by the cameras are largely identical. Small differences can arise from the position of the sensors, which are not positioned completely identically in the imaging paths, or from assembly inaccuracies of the mounts and/or the two second relay lenses. This can result in a slight offset in the images of the cameras. This can be a translation, a rotation and/or a difference in scale.

Such minor differences in the images of the two image paths can be electronically compensated in post-production by digitally comparing the images from both cameras and electronically adjusting the geometry of the images to each other. This is called electronic registration, which ensures that the two cameras image a scene completely congruent with each other.

An alternative to electronic registration is mechanical registration. For this purpose, the beam splitter system can comprise a mechanical displacement device which makes the sensor of at least one camera displaceable in a horizontal and/or vertical direction parallel to the sensor plane. For example, the displacement device can comprise at least one bearing device which is designed to shift the lens-sided mount on the relay unit so that it can be displaced in a plane perpendicular to the imaging path. This can be implemented, for example, with a guide, a linear guide, a cross roller bearing or a slide. A camera mounted on the lens-sided mount can thus be displaced (moved) in the plane perpendicular to the imaging path (and parallel to the sensor plane) in a horizontal and/or vertical direction, whereby the used sensor section is also displaced in a horizontal and/or vertical direction with respect to the imaging path. The displacement device described here thus makes it easy to displace the sensor or the sensor section with respect to the imaging path of the relay unit and thus bring it into the desired position.

From a design point of view, it is advantageous to provide a first horizontal displacement device for the camera of the first imaging path, which enables the camera or sensor (sensor section) to be displaced parallel to the horizontal sensor edge, and a second vertical displacement device for the camera of the second imaging path, which enables the camera or sensor (sensor area) to be displaced in the vertical direction. This means that both horizontal and vertical displacement can be implemented with comparatively little design effort. Alter-natively, it is also conceivable that the first displacement device for the camera of the first imaging path and/or the second displacement device for the camera of the second imaging path are each designed to (individually) displace the cameras in the vertical and horizontal directions. This alternative design is more complex in terms of design, but more flexible to use, since both cameras can be displaced individually in the horizontal and vertical directions. Regardless of the specific designs of the displacement devices described here, these can also include a fine adjustment for the displacement in the horizontal and/or vertical direction. Such a fine adjustment of the displacement can be achieved, for example, with one or more adjustment spindle(s). Once a displacement has been determined and set, it should also be able to be fixed. This can be done either in a self-locking manner, for example by means of a self-locking adjustment spindle, a clamp or a locking of the displacement device.

By means of a horizontal shift of the sensor section on the lens-sided mount of the relay unit of one imaging path and a vertical shift on the lens-side mount of the other imaging path, a very precise registration of the two images can be achieved. To adjust this mechanical shift, the image signals from the cameras can be blended over one another, for example, making the registration of the signals visible and allowing adjustment accordingly.

For many applications, such mechanical registration is sufficient. If pixel-accurate registration is required, this can be achieved at a later stage by further electronic fine-tuning in post-production.

It can also be advantageous to provide a mechanical adjustment option for the rotation of a camera around the optical axis in order to compensate for even small differences in the rotation of the images relative to one another. For this purpose, the beam splitter system can also have a rotation device which is designed to rotate the lens-sided mount on the light exit side of the relay unit for the first imaging path and/or the second imaging path around the optical axis. If a camera is flanged to the respective mount (which defines a rotational starting position), the image on the sensor can be rotated by rotating the mount relative to the imaging path. It is advantageous if the rotation of such a mount can also be fixed. This can be achieved, for example, by clamping or by means of a self-locking fine adjustment, for example via an adjustment spindle of the rotation device.

The horizontal and vertical adjustment of the sensor section presented here only requires an adjustment range of a few tenths of a millimeter, as it only brings the otherwise identical images of the sensors into alignment. If the adjustment range of the horizontal and/or vertical shifting device is increased to an adjustment range of a few millimeters, this can also be used to adjust image sections, as presented below.

### Use for Different Image Sections

When different aspect ratios are required for the distribution of a scene, a maximum-sized sensor section is usually selected for the recording, from which the two aspect ratios can be created by cropping the image. This is common, for example, when a film project with an aspect ratio of 2.4:1 is shot for theatrical release in so-called Cinemascope and an aspect ratio of 16:9 is also to be provided for television. In this case, a maximum-sized sensor area is usually exposed, from which both formats are then created by cropping. In this case, this is relatively easy to achieve, since both evaluations have a horizontal orientation. This means that the horizontal image side is longer than the vertical in both cases.

For distribution in social media, a vertical image orientation is increasingly required, often in an aspect ratio of 9:16. Such an aspect ratio can be easily displayed on a mobile phone held upright. If you want to create such an aspect ratio of 9:16 by simply cropping a horizontally oriented original image, this leads to a loss of a significant amount of image information on the sides of the image. This can lead to a scene no longer being represented in a comprehen-sible manner if, for example, actors who are located at the side of the image are no longer shown due to the image cropping.

It is more advantageous if a second vertically oriented image section is recorded during the recording, which uses the sensor in its maximum size. This can be achieved by mounting one of the cameras rotated by 90° around the optical axis of the imaging path on its mount. In this case, one camera records a horizontal image orientation and the other a vertical image orientation. The images overlap in an area in the middle of the image, but both use an identically sized sensor area, which is considerably larger than if the vertical orientation were only created by image cropping.

A PL mount or an LPL mount are common connections between a camera and recording lenses of professional film equipment. In addition to a guide ring that centers the lens to the sensor, they also have a registration pin that engages in a guide slot that is rotated by 90°. Using this pin, recording lenses can be connected to a camera at a defined angle that can be rotated by +/−90° or 180°. Conversely, this can also be used to attach a camera rotated by 90° to a PL or LPL mount of the relay unit. This means that by using a PL or LPL mount, it is easy to change from a horizontal to a vertical image orientation by rotating the mount by 90°, so the camera is no longer mounted upright on the relay unit, but rotated by 90°.

If the relay unit does not have a PL or LPL mount, but instead has a mount from Canon, Nikon or Sony or another manufacturer, for example, then the lens-sided mount of the relay unit of at least one of the cameras can be mechanically mounted using the rotation device described above so that it can be rotated 90° around the optical axis. This rotation can advantageously be locked at 90°.

If the sensor of one camera records a vertical image orientation and the sensor of the other camera records a horizontal one, this can lead to sections not being optimally aligned, particularly in their vertical orientation. For example, if a person is depicted in both variants, the head would probably be depicted relatively close to the top edge of the image in a horizontal orientation. If the image section on the other camera with a vertical orientation is only rotated centrally by 90°, then the actor's head would in this case be positioned relatively “low” in the image.

This is referred to as the “headroom”, the distance between a head or object and the upper edge of the image. For aesthetic reasons, this is adjusted accordingly for different aspect ratios so that the vertical placement of an actor appears consistent for both evaluations. For this purpose, it is advantageous if the vertical image section of the cameras can be adjusted to each other so that a consistent headroom is achieved in both cases.

Such an adjustment of the headroom can be determined and set using the vertical shifting device explained above. The image section of the vertical orientation can be shifted so that the image content is placed “higher”, or the displayed image section of the horizontal orientation can be shifted so that the image content is placed “lower”.

For the appropriate positioning, it is advantageous if both the recording lens and the relay unit can display or transmit an image circle that is larger than the sensor area used for the image in order to ensure sufficient space for such a shift.

It can also be advantageous if at least one camera is designed to be adjustable in the horizontal image orientation, for example in order to position an important image element horizontally so that it is as clearly visible as possible.

It is also conceivable that the resolutions, sensor sizes or pixel densities of the cameras are different when creating different aspect ratios. For example, it may make sense to record an aspect ratio of 2.4:1 with the maximum possible resolution with a very high-resolution camera for a high-resolution cinema release, while the other camera records with a significantly lower resolution, which is sufficient for the requirements of social media releases, for example. It is of course also possible to combine different frame rates, exposure times, filters and different aspect ratios as desired.

### Synchronization of the Cameras

When two or more cameras of the beam splitter system are used for simultaneous recording, it is advantageous if the cameras are synced in such a way that they can share control signals, clock signals, time signals or metadata with each other.

This includes the ability to start and stop recordings of the cameras at the same time in order to record an identical time window of an event. This can be achieved by sending a start or stop signal to the at least two cameras at the same time via a remote switch.

Another common method of simultaneously triggering and stopping a recording from two or more cameras is a so-called master-slave connection of the cameras. In this case, one of the cameras is designated as the master camera, while the others run as slave cameras. Settings or control signals are sent from the master camera to the slave cameras and executed simultaneously. Such a connection is usually made via a electronical connection, often via an Ethernet protocol or Bluetooth.

Particularly with regard to the further processing and distribution of the film clips produced by the cameras, it is advantageous if the recorded image sequences share a uniform format-ting or uniform metadata if applicable. This means that a sequence of cuts from the recorded material of one camera can be transferred to the recorded material of the other camera automatically or largely automatically. Therefor, a second version of a film can be produced with comparatively little effort, which has the desired variation, which is determined, for example, by a different frame rate or a different aspect ratio.

Therefore, the film clips recorded by the cameras should have the same clip names, contain the same time stamps and be in sync to each other if the cameras have the same frame rate. Identical time stamps can be achieved by connecting the cameras to an external clock or by synchronizing their internal clocks with each other.

If both cameras share the same frame rate, it is best to record an image sequence in-phase. This means that the recording of each individual frame begins at the same moment in time and ends at the same moment at a later time. For example, the motion blur of a moving object is also depicted in the same way by both cameras.

The synchronization of the exposure phases of the cameras can be achieved via an external sync generator, which supplies the cameras with a common clock signal. Depending on the camera type, such synchronization is often also possible in master-slave mode.

In contrast to in-phase, phase-stable can mean that the start and/or end of the exposure of the individual images is not at the same time. This is the case, for example, when two cameras are running at the same frame rate but with different exposure times. In this case, neithe the start nor the end of an individual image exposure, or both events, may occur at the same time, depending on how these two exposure windows are positioned in relation to each other.

It is also expressly possible for both cameras to run phase-shifted to each other. This can mean, for example, that one camera begins an exposure while the second ends its exposure and vice versa. In a phase-shifted recording with a 180° shutter each, both cameras are exposed for the same length of time and record the light in opposing time windows that do not overlap in time.

This can be used if, for example, light sources are assigned to the system in such a way that they are also synchronized with the exposure frequencies of the cameras and illuminate a scene in a pulsed manner and only in the exposure phase of one or the other camera. This makes it possible to have light sources that are only visible in one or the other version of an image sequence. For example, two completely different lighting variants can be recorded from one scene. These can be combined with each other in any mixing ratio during editing or combined with each other as a dynamic transition at any time and with any fade duration.

If one camera does not run at the same frame rate as the other camera, but at a multiple of the frame rate, a phase-stable coupling of the cameras is usually also possible, depending on the camera type, and should be used if possible.

If the exposure phases of the cameras can no longer be synchronized due to different frame rates, editing sequences of a variant can also be created quickly and largely automatically using the time stamps of the individual images and the assignment of clip names.

With regard to the (mechanical) design of the beam splitter system according to the invention, it should be added that the beam splitter system can not only comprise a flange-mountable recording lens and flange-mountable cameras, which are connected to the relay unit by means of standardized mounts. It is also possible for both the cameras and the recording lens to be combined in an inseparable unit with the relay unit and form a one-piece beam splitter system. If, for example, the cameras are integrated into the system, this makes it possible to achieve a very compact design, since electronic components can be combined and not every camera needs to have its own housing, its own image processing and its own image recording. The exact mechanical alignment of the sensors, especially with regard to their congruence, can also be implemented more easily in a closed system.

One advantage of integrating the recording lens into a closed system of a one-piece beam splitter device is, for example, that the pupil positions of the recording lens and the first relay lens can be better coordinated at the intermediate image. Such coordination of the pupil positions is much easier to achieve if freely selectable lenses that already exist on the mar-ket are not used. It is also possible that only the recording lens or only one or more cameras are designed to be inseparable from the relay unit.

### BRIEF DESCRIPTION OF THE DRAWINGS

The invention is explained in more detail below by way of example only with reference to the figures.

FIG. 1 shows in a schematic representation an embodiment of a beam splitter system according to the invention with a relay unit, a recording lens that can be detachably mounted on the relay unit and two detachably mountable cameras.

FIG. 2 shows in a schematic cross-sectional representation a further embodiment of a beam splitter system according to the invention, which is designed as a one-piece beam splitter system.

FIG. 3 shows in a simplified schematic cross-sectional representation a detailed view of the relay unit of a beam splitter system with two beam splitter elements and more than two imaging paths.

FIG. 4 shows an arrangement of different sensor sections of both recording cameras of a beam splitter system according to the invention.

FIG. 5 shows a highly simplified perspective view of a vertical and horizontal displacement device of the mounts on the relay unit.

FIG. 6 shows in a simplified schematic representation an embodiment of a beam splitter system according to the invention with associated lighting device.

### DETAILED DESCRIPTION

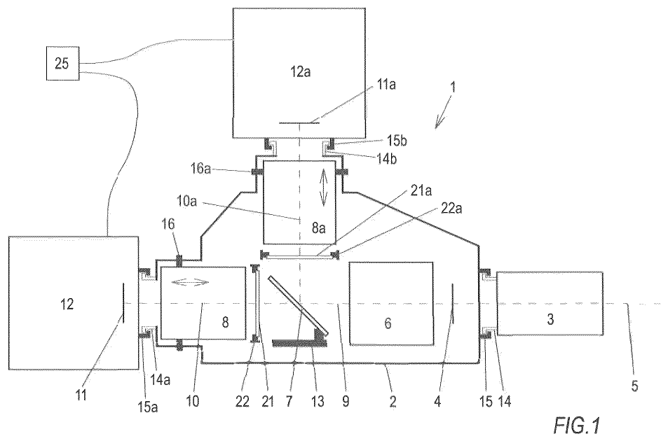

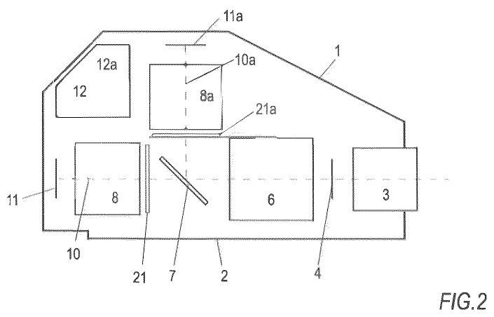

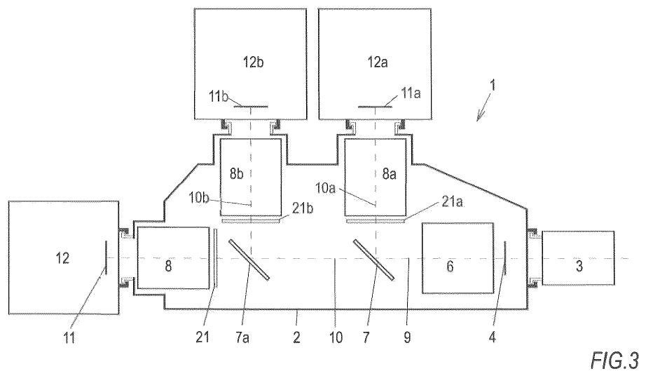

FIG. 1 shows an embodiment of a beam splitter system 1 according to the invention in simplified form. The light 5 emitted or reflected by a scene to be recorded (not shown in FIG. 1, FIG. 2 and FIG. 3) penetrates through the recording lens 3 into the relay unit 2 and is imaged as a real intermediate image 4 in the beam path. Such a recording lens 3 can be a fixed focal length or a zoom lens.

The first relay lens 6 positively refracts the intermediate image 4 to infinity. A collimated beam is advantageous as it does not change the image due to the insertion of plane-parallel optical elements in the imaging beam path.

The first relay lens 6 is matched to the second relay lenses 8, 8a in such a way that there is a sufficient distance between them along the optical axis so that at least one beam splitter element 7 can be inserted between them, which splits the imaging beam path 9 into a transmitted imaging path 10 and a reflected imaging path 10a. The beam path between the first relay lens 6 and the two second relay lenses 8, 8a is advantageously essentially parallel.

By means of the second relay lens 8 of the transmitted imaging path 10, the intermediate image 4 is imaged on the sensor 11 of the camera 12. By means of the second relay lens 8a of the reflected imaging path 10a, the intermediate image 4 is further imaged on the sensor 11a of the camera 12a.

Both sensors 11, 11a are thus provided with an identical image circle of an identical viewing point. Provided that the beam path between the first relay lens 6 and the second relay lenses 8, 8a is essentially parallel, the focal lengths of the first relay lens 6 and the associated second relay lenses 8, 8a are selected to be essentially the same so that the image displayed on the respective sensors 11, 11a have the same size as the intermediate image 4. Advantageously, the focal lengths of the second relay lenses 8, 8a can be determined to be slightly longer in a range of up to 10% than those of the first relay lens 6, which leads to a corresponding enlargement of the image on the respective sensors 11, 11a compared to the intermediate image 4 and helps to reduce vignetting and edge blurring without fundamentally changing the focal length characteristics of the recording lens 3. It is also possible for one of the two second relay lenses 8, 8a to have a focal length that is significantly different from that of the other of the two second relay lenses 8, 8a, for example to record an enlarged image section or to compensate for a difference in size of the sensors 11, 11a of different types of cameras 12, 12a. In principle, any ratio of focal lengths of the first relay lens 6 to the second relay lenses 8, 8a is possible.

The recording lens 3 is detachably connected to the relay unit 2, whereby the recording lens 3 has a lens-sided mount 14 on the light exit side, which engages in a camera-sided mount 15 on the relay unit 2 and can be connected and locked in a form-fitting, twist-proof manner. Such a lens-sided mount 14 and the corresponding camera-sided mount 15 are advantageously existing standard connections, such as those used by the companies like ARRI, Panavision, Sony, Canon, Nikon or Fuji. An advantageous embodiment is the standard of a PL mount or an LPL mount used worldwide in the professional film sector as such a lens-sided mount 14 or camera-sided mount 15.

The cameras 12, 12a mounted on the relay unit 2 advantageously also have a standardized camera-sided mount 15a, 15b, which engages in a lens-sided mount 14a, 14b of the relay unit 2 and can be connected and locked with it in a form-fitting, twist-proof manner. This connection is also advantageously designed as an existing standard connection and has mounts from the companies like ARRI, Panavision, Sony, Canon, Nikon or Fuji. Here too, a PL mount or LPL mount as the de facto standard in the film industry is an advantageous solution.

The second relay lens 8, 8a each have a focusing unit 16, 16a, by means of which a displacement of the relay lenses 8, 8a in the axial direction along the respective imaging paths 10, 10a is possible. This displacement allows the second relay lenses 8, 8a to be adjusted (inde-pendently of one another) so that the image is focused on the respective sensors 11, 11a. The respective focusing units 16, 16a are advantageously designed to be lockable or self-locking so that an adjustment during the recording is not possible unintentionally, although this is not shown in more detail in the illustration. The respective focusing units 16, 16a are only used to adjust the flange focal distance of the second relay lenses 8, 8a to the respective sensors 11, 11a.

Instead of the focusing units 16, 16a for the second relay lenses 8, 8a, the flange focal distance can also be adjusted using shims or a closely toleranced manufacturing process. The actual focus adjustment of a scene, however, takes place on the recording lens 3.

A filter 21, 21a can be assigned to both imaging paths 10, 10a, which is arranged between the beam splitter element 7 and the second relay lenses 8, 8a. Such a filter 21, 21a is advantageously designed so that it can be exchanged and can be individually determined and used depending on the desired filtering. This can be a gray filter, polarization filter, long-pass filter, short-pass filter, soft focus filter, star filter, streak filter or other filters. It can often be desirable for only one of the imaging paths 10, 10a to have such a filter, since this allows two different variants to be recorded, each with and without filtering.

A sync generator 25 can be connected to both cameras 12, 12a and supplies them with clock signals and/or time code information so that the cameras 12, 12a can run in-phase, phase-stable or phase-shifted to each other. In a in-phase recording, both cameras 12, 12a run at the same frame rate and the start and end of the recording of each individual frame occurs simultaneously. In a phase-stable recording, the exposure time of both cameras 12, 12a can be different, as can the start point and/or the end point of an exposure process of an individual image. Nevertheless, the temporal relationships of the respective start and end of an individual image recording remain constant. In a phase-shifted recording, the sensor 11, 11a of one camera 12, 12a is exposed while the other sensor 11, 11a is not exposed and vice versa. Instead of a sync generator 25, a direct connection (not shown here) as a master-slave connection between the cameras 12, 12a is also possible.

The beam splitter element 7 can have a splitting ratio of 50:50 or any other splitting ratio. The beam splitter element 7 is advantageously connected to the relay unit 2 in a separable (replaceable) manner by means of a beam splitter holder 13, so that different beam splitter elements 7 with different splitting ratios can be positioned and fixed in the imaging beam path as required. The beam splitter holder 13 of the beam splitter element 7 advantageously engages in the relay unit 2 in a form-fitting manner and enables precise positioning in the beam path. The changing device of the beam splitter element 7 and the beam splitter holder 13 is not shown in more detail in the illustration.

The embodiment shown in FIG. 2 differs from the embodiment shown in FIG. 1 essentially in that both the recording lens 3 and the cameras 12, 12a with the associated sensors 11, 11a are integrated into the beam splitter system. The recording lens 3 can be designed as a fixed focal length or a zoom lens.

By integrating the cameras 12, 12a into the beam splitter system 1, it is possible in particular to combine the electronics of the cameras 12, 12a and to synchronize them more easily with each other. The use of a permanently installed recording lens 3 also facilitates the optical design of the first relay lens 6, which is coordinated with this.

In principle, one or more of the cameras 12, 12a can be separable or permanently integrated into the beam splitter system 1. Likewise, the recording lens 3 can be designed as a separable or fixed component of the system.

FIG. 3 shows an embodiment in which the beam path 9, which is imaged by the first relay lens 6 essentially to infinity, is split by a first beam-splitting element 7 into a transmitted first imaging path 10 and a reflected, second imaging path 10a, which generates an image on the sensor 11a of the camera 12a by means of a second relay lens 8a. The transmitted imaging path is further split by means of a second beam splitter element 7a and imaged by the relay lenses 8, 8b on the sensors 11, 11b of the cameras 12, 12b.

In this embodiment, the three cameras 12, 12a, 12b are each provided with identical image circles of the image from the intermediate image 4 of the recording lens 3. The example shows that more than two imaging beam paths are also possible.

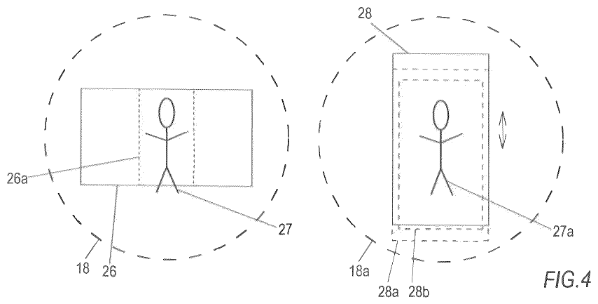

FIG. 4 shows two image circles 18, 18a which are imaged on the sensor plane of the cameras 12, 12a. Advantageously, the intermediate image generated by the recording lens 3 and the image circles 18, 18a transmitted by the first relay lens 6 and the second relay lenses 8, 8a are larger than the image windows 26, 28, 28a, 28b which are recorded as sensor sections by the sensors 11, 11a of the cameras 12, 12a.

This makes it possible to slightly shift the image windows 26, 28, 28a, 28b in the horizontal and/or vertical direction within the image circles 18, 18a provided. This shift can be used to align the registration of the two specific sensor sections or to modify an image section.

The left illustration shows a schematically represented actor 27, which is imaged by the recording lens 3 and by means of the relay lenses 6, 8, 8a on one of the two sensors 11, 11a, in a horizontally oriented image window with an aspect ratio of 16:9. Such an image section can be required in high resolution for television evaluation and cinema production, for example. The dashed line shows a vertical cutout from the horizontal image window 26a, as may be desired for use in the social media sector, for example, since a vertical image aspect ratio of 9:16 is often used here. It can be seen that simply cropping to an aspect ratio of 9:16 would crop the image by more than a third on both sides and elementary areas of the image would be lost.

The right-hand illustration of FIG. 4 shows the identical image circle 18a as it is provided in the second imaging path and the image of the actor 27a in identical size. The vertically oriented image window 28 is achieved by mounting the camera 11, 11a of an imaging beam path rotated by 90° around the optical axis. This is possible using the PL or LPL mounts already described, as these have a groove rotated by 90° in each case, into which a registration pin on the camera mount engages.

It also shows that the actor 27a is positioned relatively “low” in the vertically oriented image window 28 and the area above his head to the upper edge of the image is comparatively large. It is therefore advantageous if at least one of the cameras 12, 12a has a displacement device with which the vertical image section can be determined and adjusted. Such a shifted vertically oriented image window 28a shows an image section shifted downwards, which shows less space above the actor's head and appears more organic.

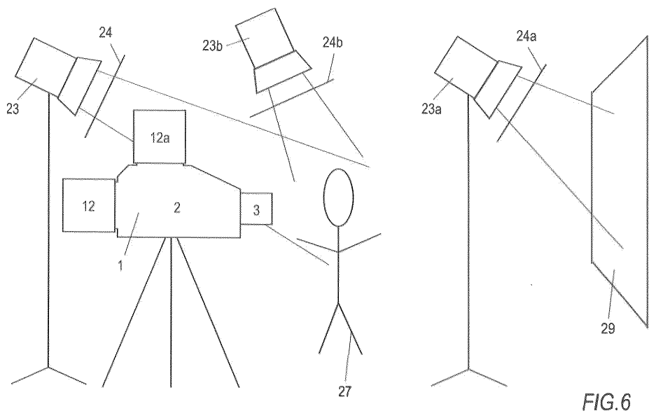

Such a vertical shift can be achieved by making the lens-sided mount of the relay unit 2 in the imaging path of one second relay lens 8, 8a movable and fixable parallel to the vertical image edge of the sensor 11, 11a. This is explained in more detail below in FIG. 6.

It is also conceivable that a shifted and smaller vertically oriented image window 28b is determined. This can be done by reducing the area of the recorded sensor section or, for example, by means of a camera 12, 12a of a different type that has a sensor 11, 11a with a lower resolution, since a lower resolution is often sufficient for evaluation in social media channels.

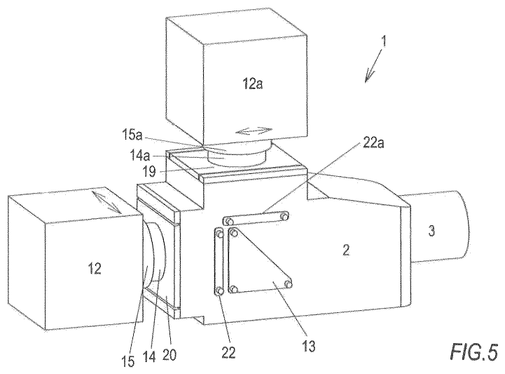

FIG. 5 shows a simplified perspective view of a beam splitter system 1 with a recording lens 3 and two cameras 12, 12a, which are connected to the relay unit 2, which has a vertical and a horizontal displacement device 19, 20. The two camera-sided mounts 15, 15a of the cameras 12, 12a engage in the lens-sided mounts 14, 14a of the relay unit 2 and are locked there.

By means of the horizontal displacement device 20, the lens-sided mount 14, which is rigidly attached to it, can be displaced horizontally parallel to the sensor plane. In this case, only the lens-sided mount 14 is displaced, the second relay lens assigned to it (not shown here) remains fixed centrally in the optical axis. By displacing the lens-sided mount 14, the camera 12 together with its sensor 11 is also displaced relative to the transmitted image path, whereby the position of the image on the sensor section also shifts. This setting can be used to register the two sensors 11, 11a in a horizontal orientation or to determine a changed horizontal image section.

By means of the vertical displacement device 19, the lens-sided mount 14a, which is rigidly attached to it, can be moved in a vertical direction parallel to the sensor plane. In this case, only the lens-sided mount 14a is moved, the second relay lens assigned to it (not shown here) remains fixed centrally in the optical axis of the reflected image path. By moving the lens-sided mount 14a, the camera 12a and its sensor 11a are also moved relative to the reflected image path, which also shifts the position of the image on the sensor section. This setting can be used to register the two sensors 11, 11a in a vertical alignment or to determine a changed vertical section.

Such a displacement device 19, 20 can be designed, for example, by means of a sliding guide, a linear guide, a carriage or a cross roller bearing. The displacement can advantageously be determined precisely by means of a fine adjustment (not shown here), for example via a threaded spindle. For registration, only a displacement of a few tenths of a millimeter is necessary; for determining an image section, the adjustment range should cover a few millimeter. The determined and set displacements can also advantageously be fixed, for example via a self-locking design (not shown here), a clamp, a screw connection or a detent.

It is also conceivable that the horizontal displacement is carried out on the reflected imaging path and the vertical displacement on the transmitted imaging path. Likewise, a displacement device can be provided on one or both imaging paths, which enables adjustment in the horizontal and vertical directions, as is known with cross tables.

An advantageous further development is the possibility of also offering a rotation around the center of one of the lens-side mounts 14, 14a via a device not shown in FIG. 5. Such a rotation can be used to fine-tune the registration of minimal rotation errors in the image of the two cameras 12, 12a, or to bring the sensor alignment into a vertical or horizontal orientation by rotating it by 90°.

FIG. 5 also shows two inserted filter holders 22, 22a, which are mounted on the relay unit 2. The filter holders 22, 22a advantageously also include a cover plate, which protects the relay unit 2 from light entering at this point. As an example, a screw connection is shown here in a simplified manner, with which the filter holders 22, 22a can be attached to the relay unit. This is just one of many possible embodiments; catches, clamps or locks are also conceivable.

The inserted beam splitter holder 13 is also shown in a simplified form. This advantageously includes a cover plate that protects the relay unit 2 from light entering at this point. As an example, a screw connection is shown here in a simplified form, with which the beam splitter holder 13 is attached to the relay unit 2. This is just one of many possible embodiments; catches, clamps or locks are also conceivable.

FIG. 6 shows in a simplified schematic representation an embodiment of a beam splitter system 1 according to the invention with associated lighting device 23, 23a, 23b, 24, 24a, 24b. A performer 27 is illuminated by a light source 23 which emits exclusively light of the visible spectrum or is filtered to the spectrum of visible light by means of a filter 24, for example by means of a short-pass filter which has a cutoff wavelength in the range from 700 nm to 780 nm.

The background 29 is illuminated by a light source 23a which emits exclusively infrared or near-infrared light or is filtered to the spectrum of infrared light by means of a filter 24a, for example by means of a long-pass filter which has a cutoff wavelength in the range from 700 nm to 780 nm.

The cameras 12, 12a are also designed using corresponding long-pass and short-pass filters with a cutoff wavelength in the range of 700 nm to 780 nm so that one camera records only visible light and the other camera records only infrared light. The light emitted by the light source 23 is therefore not visible to the camera sensitive to infrared light, while the light emitted by the light source 23a is not visible to the camera sensitive to visible light. The background 29 illuminated by the infrared light can therefore be used as a pure mask channel, for example to later combine the actor 27 with a new background.

In another application example, a soft, diffuse surface light 23 emits only visible light onto an actor 27 or a scene by means of a filter 24 or through its luminous properties. Another point-shaped, hard light source 23b emits only infrared or near-infrared light onto the actor 27 through its luminous properties or through a filter 24b. The cameras 12, 12a are sensitive to either only visible or only infrared light through appropriate and already explained filtering. Thus, one of the cameras 12, 12a records a soft, diffusely illuminated image of the actor 27, while the other records a hard light gradient as an own mask channel in the infrared spectrum, which does not contain any visible light components. If the recording of the diffusely illuminated channel of visible light is divided into two different gradings in the image processing, one corresponding to a dark shadow area and the other to a bright, glaring sunlight, the mask signal of the infrared recording can be used to combine these two lighting moods to create an impression in which the actor 27 is standing in glaring sunlight.

A further development of the associated lighting device can be achieved if the cameras 12, 12a record phase-shifted to each other and the light sources 23, 23a, 23b are synchronized with the cameras 12, 12a and emit a pulsating light. The exposure of the first camera 12 takes place in a time window in which the other camera 12a is not recording and vice versa. The light sources 23, 23a, 23b emit the light as periodic light pulses, which are synchronized in such a way that the light sources only emit their light during each exposure phase of the first camera 12 or only during each exposure phase of the second camera 12a. In this way, image sequences with completely different lighting situations can be recorded and later combined, mixed or implemented as a fade as desired.

The application examples presented here are only examples of a large number of applications of the beam splitter system 1 according to the invention and an associated lighting device. For example, one or more of the light sources 23, 23a, 23b can be polarized by polarizing filters 24, 24a, 24b. If an additional polarization filter (not shown here) is also placed in one of the imaging paths of the cameras 12, 12a, which has a polarization direction rotated by 90°, this camera records a cross-polarized version of the image in which the highlights are eliminated.

### LIST OF REFERENCE SYMBOLS

1 beam splitter system
2 relay unit
3 lens
4 aerial photograph
5 radiation
6 first relay optics
7,7a beam splitter element
8, 8a, 8b second relay optics
9 imaging beam path
10 first mapping path
10a second mapping path
10b third mapping path
11, 11a, 11b sensor
12, 12a, 12b camera
13 beam splitter mount
14, 14a, 14b lens-side mount
15, 15a, 15b camera-side mount
16, 16a focusing device
18, 18a image circle
19 vertical displacement device
20 horizontal displacement device
21, 21a, 21b filter
22, 22a filter holder
23, 23a, 23b Light source
24, 24a, 24b light source filter
25 sync generator
26 horizontally oriented image window
26a vertical cutout from horizontal image window
27, 27a Actors
28 vertically oriented image window
28a shifted, vertically oriented image window
28b shifted and reduced, vertically oriented image window
29 background

1. A beam splitter system comprising: a recording lens, at least two cameras and a relay unit with at least one beam splitter element, a first relay lens and at least two second relay lenses, wherein the recording lens provides a real intermediate image which is imaged by the first relay lens, the at least one beam splitter element divides the imaging beam path of the first relay lens into at least two imaging paths, and the at least two second relay lenses in the at least two imaging paths each image the intermediate image onto a sensor of the at least two cameras, the focal length of the first relay lens does not differ from the focal lengths of the at least two second relay lenses by more than 10% and the beam splitter system further comprises a device to selectively modify the image to be imaged in at least one of the at least two imaging paths.

2. The beam splitter system according to claim 1, wherein the beam splitter element is detachably mounted in the relay unit in a predetermined position in the imaging beam path.

3. The beam splitter system according to claim 1, wherein the beam splitter element splits the imaging beam path of the first relay lens according to a predetermined intensity ratio and/or according to a polarization of the imaging beam and/or a desired spectral range of the imaging beam.

4. The beam splitter system according to claim 1, wherein the device comprises at least one filter arranged behind the beam splitter element in at least one of the two imaging paths.

5. The beam splitter system according to claim 4, wherein the at least one filter is arranged interchangeably between the beam splitter element and the at least one second relay lens.

6. The beam splitter system according to claim 4, wherein the at least one filter is mounted rotatably about an optical axis of the imaging path and its rotational position can be adjusted from outside.

7. The beam splitter system according to claim 4, wherein the at least one filter is a gray filter, a polarization filter and/or a long-pass or short-pass filter.

8. The beam splitter system according to claim 7, wherein a cutoff wavelength of the long-pass or short-pass filter is in the range of 700 nm-780 nm.

9. The beam splitter system according to claim 1, wherein the first relay lens and the at least two second relay lenses are designed to transmit an image circle of at least 32 mm diameter.

10. The beam splitter system according to claim 1, wherein the first relay lens and the at least two second relay lenses are designed to transmit a light intensity of at least aperture 2.

11. The beam splitter system according to claim 1, wherein the at least one of the second relay lenses is displaceable and fixable along an optical axis in order to adjust a focus of this lens to a sensor plane.

12. The beam splitter system according to claim 11, wherein the displacement of the at least one second relay lens with respect to the other second relay lens is adjustable such that a depth of field ranges of two images partially overlap.

13. The beam splitter system according to claim 1, wherein the recording lens and/or at least one of the cameras is separably connected to the relay unit.

14. The beam splitter system according to claim 13, wherein the recording lens and/or at least one of the cameras is connected to the relay unit by a camera mount.

15. The beam splitter system according to claim 14, wherein the mount is a PL or LPL mount.

16. The beam splitter system according to claim 1, wherein the sensors of the cameras are synchronized with each other in time.

17. The beam splitter system according to claim 1, wherein the beam splitter system has a displacement device which is designed to displace at least one of the cameras parallel to its sensor plane in a horizontal and/or vertical direction.

18. The beam splitter system according to claim 1, wherein the beam splitter system comprises a device which rotates at least one of the cameras by 90° about an optical axis with respect to a predetermined starting position.

19. The beam splitter system according to claim 1, wherein the sensors of the cameras are set so that they record the same image sections and/or have the same exposure times.

20. The beam splitter system according to claim 1, wherein the beam splitter system further comprises an illumination device to emit light of a predetermined polarization direction and/or light of a specific spectral range and/or pulsating light which is synchronized to the frame.
